(19) United States
(12) Patent Application Publication
(10) Pub. No.: US 2005/0234788 A1
(43) Pub. Date: Oct. 20, 2005

(54) Method and system for billing for internet services for ad-hoc network nodes

(76) Inventors: John G. Hudson, Laguna Niguel, CA (US); Rolf P. Dietiker, Laguna Niguel, CA (US); Michelle P. Bui, Irvine, CA (US)

Correspondence Address: KLEIN, O'NEILL & SINGH, 2 PARK PLAZA, SUITE 510, IRVINE, CA, 92614, US

(21) Appl. No.: 10/969,563

(22) Filed: Oct. 20, 2004

Related U.S. Application Data
(60) Provisional application No. 60/563,425, filed on Apr. 19, 2004.

(51) Int. Cl. G06F 17/60

(52) U.S. Cl. 705/34; 705/1

(57) ABSTRACT

A method and system for billing for Internet access for an ad-hoc network node, for example, an aircraft is provided. The method includes, receiving a message notifying when the ad-hoc network node starts operating; determining a route for the ad-hoc network node; and determining duration of Internet access to the ad-hoc network node during ad-hoc network node travel. The message is received by a data center via the Internet that monitors the status of the ad-hoc network node. Also, the process generates a billing statement based on duration of travel and geographical area where Internet access is provided.

### CROSS REFERENCE TO RELATED APPLICATION

This application claims priority under 35 U.S.C. § 119(e)(1) to the following provisional patent application, the disclosure of which is incorporated herein by reference in its entirety Ser. No. 60/563,425, filing date Apr. 19, 2004.

### BACKGROUND OF THE INVENTION

1. Field of the Invention

This invention relates generally to network systems, and more particularly, to a method and system for billing customers for Internet services on an ad-hoc network node.

2. Description of Related Art

Computer networks exist and operate in various forms. Networks include local area networks, wide area networks, wireless networks, the Internet and others. An ad-hoc network, as used herein throughout the specification is a network that is constantly changing. An ad-hoc network node is an entity that is capable of joining or leaving the ad-hoc network at any given time.

Various entities exist that may fall within the ad-hoc network node concept described above. For example, aircrafts, ships, boats, trains, buses and even automobiles can be classified as ad-hoc network nodes if they are monitored using a network. The term node and ad-hoc network node; and network and ad-hoc network are used interchangeably throughout this specification.

Modern business and personal travel is rapidly increasing to meet the global nature of today's society. Internet usage has also become common place. Companies and individuals at a global level use the Internet for business and personal reasons. Therefore, it is desirable for individuals who are traveling via airplanes, ship, boats, automobiles or other means to have access to the Internet during travel.

Internet services on an aircraft (an ad-hoc network node) are provided by Connexion by Boeing™. Companies that provide Internet services on an aircraft (or any other ad-hoc network node) need an efficient and accurate process to charge their customers for in-flight Internet services/access. One billing option is to charge based on the duration of travel and the geographical regions where Internet services are made available, i.e., the Internet provider will bill the customer for the duration when the Internet services were active within certain geographical regions.

Conventional systems do not provide a method and system for efficiently monitoring ad-hoc network nodes, (for example, aircraft status by using ACARS and real-time data) and hence it is difficult for an Internet provider to set up billing plans. This problem becomes even more complex, because at any given time various ad-hoc network nodes are scheduled to operate in different routes and billing for Internet access becomes a difficult task.

Therefore, there is a need for a method and system that can accurately and efficiently provide billing options for Internet access on an ad-hoc network node.

### SUMMARY OF THE INVENTION

In one aspect of the present invention, a method for billing for Internet access for an ad-hoc network node is provided. The method includes, receiving a message notifying when the ad-hoc network node starts operating; determining a route for the ad-hoc network node; and determining duration of Internet access to the ad-hoc network node during ad-hoc network node travel. The message is received by a monitoring system via the Internet. Also, the process generates a billing statement based on duration of travel (for example, aircraft flight) and geographical area where Internet access is provided.

A computer-readable medium storing computer-executable process steps of a process for use in a computer system for billing for Internet access for an ad-hoc network node is provided. The medium includes, code for receiving a message notifying when the ad-hoc network node starts operating; code for determining a route for the ad-hoc network node; and code for determining duration of Internet access to the ad-hoc network node during ad-hoc network node travel. The medium also includes code for generating a billing statement based on the duration of travel and geographical area where Internet access is provided.

In yet another aspect of the present invention, an apparatus for billing for Internet access for an ad-hoc network node is provided. The apparatus includes, a storage device for storing computer executable process steps; and a processor for executing computer executable process steps for receiving a message notifying when the ad-hoc network node starts operating; determining a route for the ad-hoc network node; and determining the duration of Internet access to the ad-hoc network node during ad-hoc network node travel. The processor also generates a billing statement based on the duration of travel and geographical area where Internet access is provided.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein:

FIG. 1A1 shows a block diagram of a monitoring system for monitoring ad-hoc network nodes, according to one aspect of the present invention;

FIGS. 1A-1C show block diagrams of flight monitoring systems, used according to one aspect of the present invention;

FIG. 1D shows examples of ACARS messages;

FIGS. 1E-1F show block diagrams of system components, used according to one aspect of the present invention;

FIG. 1G shows a block diagram of a computing system for executing process steps, according to one aspect of the present invention;

FIG. 1H shows the internal architecture of the computing system in FIG. 1G; and

FIGS. 2-3 show process flow diagrams of computer-executables steps for billing for Internet services for ad-hoc network nodes, according to one aspect of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein, specifically to provide for a method and system for monitoring the ad-hoc networks in real-time and sending messages to the ad-hoc network and/or an operations center over the Internet.

A method and system is provided whereby an ad-hoc network node (for example, an aircraft) having an on-board installation for high-speed Internet access may be continuously monitored by a monitoring system via the Internet or any other network. Based on the monitoring, the present invention provides a process for billing customers for access to the Internet.

It is noteworthy that although the examples provided below to illustrate the adaptive aspects of the present invention are based on monitoring aircraft flight status, the same method and system can be used to monitor other ad-hoc nodes, for example, ships, trains, buses and/or automobiles.

To facilitate an understanding of the preferred embodiments of the invention, the general architecture and operation of a system for collecting an ad-hoc network node/aircraft's flight operations data will be described. The specific architecture and operation of the preferred embodiments will then be described with reference to the general architecture.

Data Collection System:

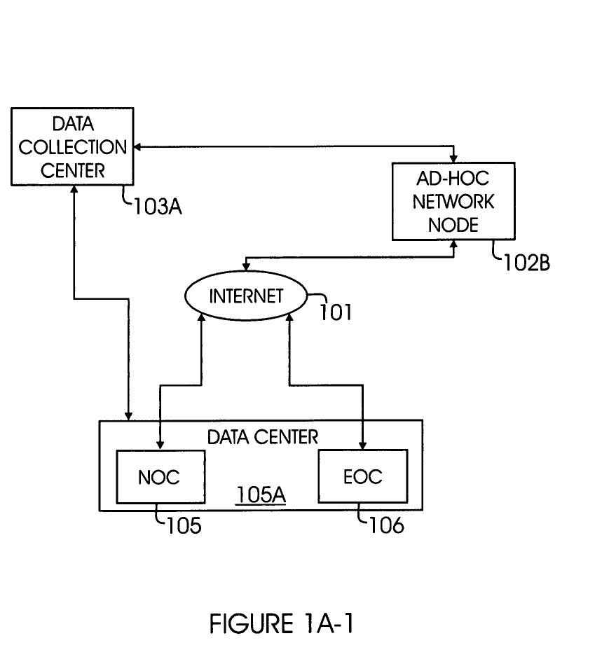

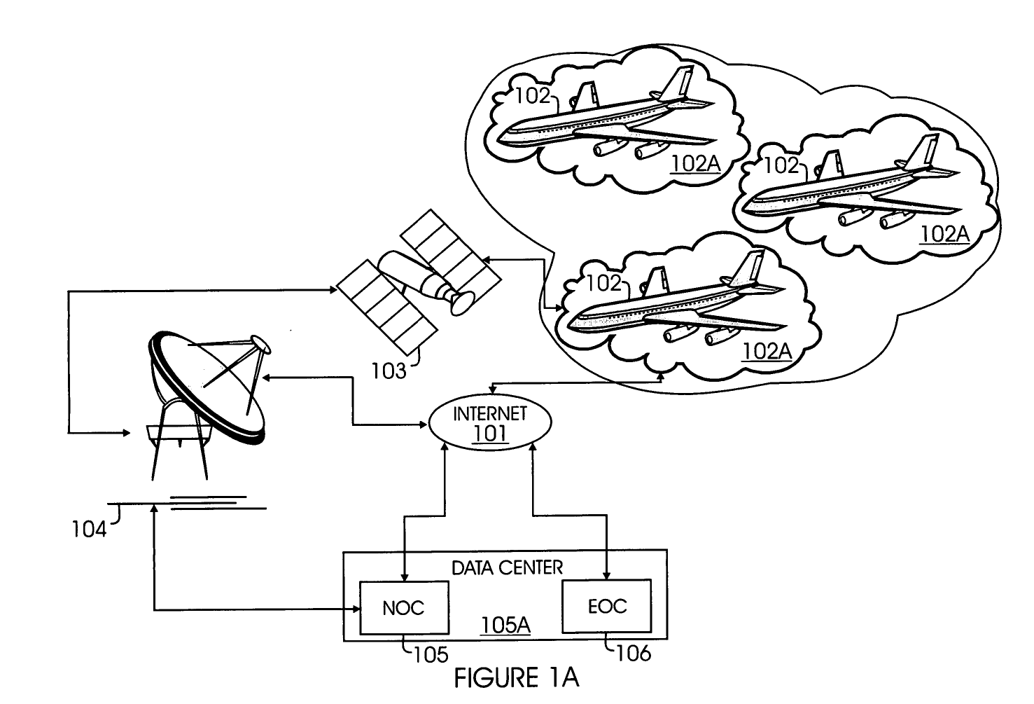

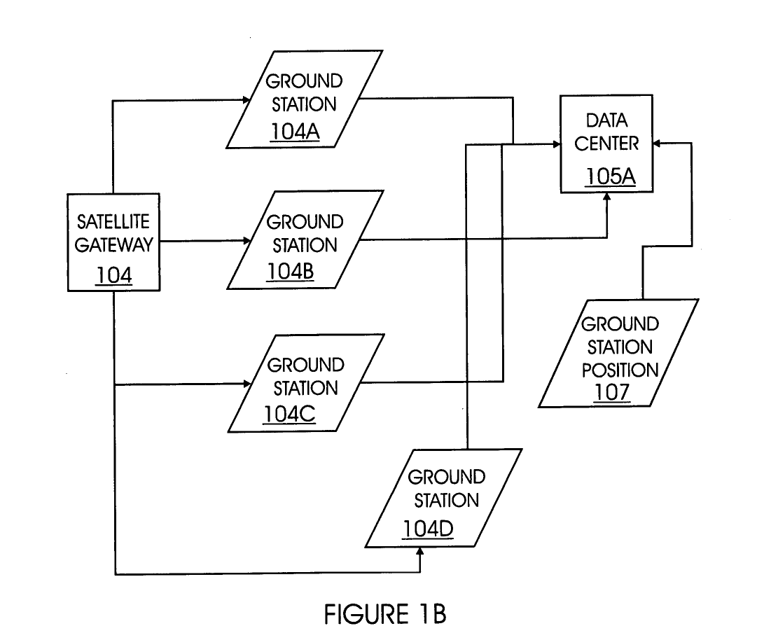

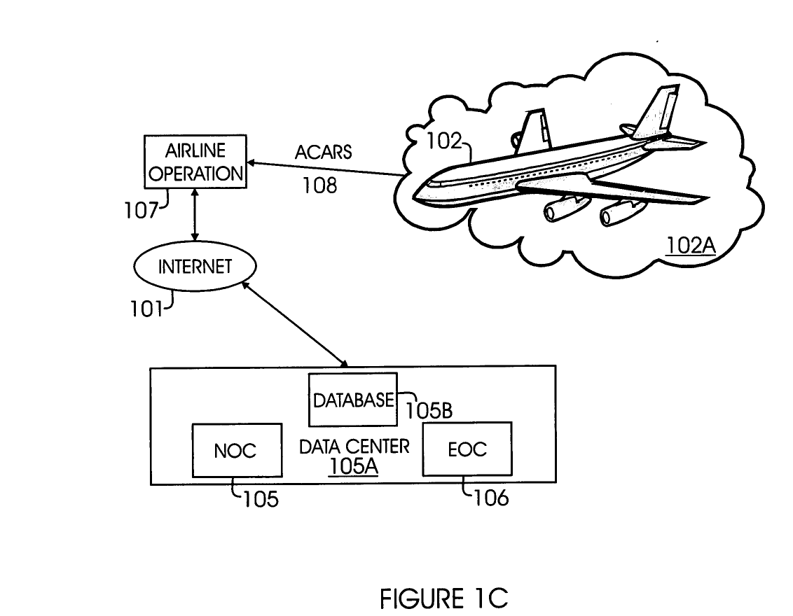

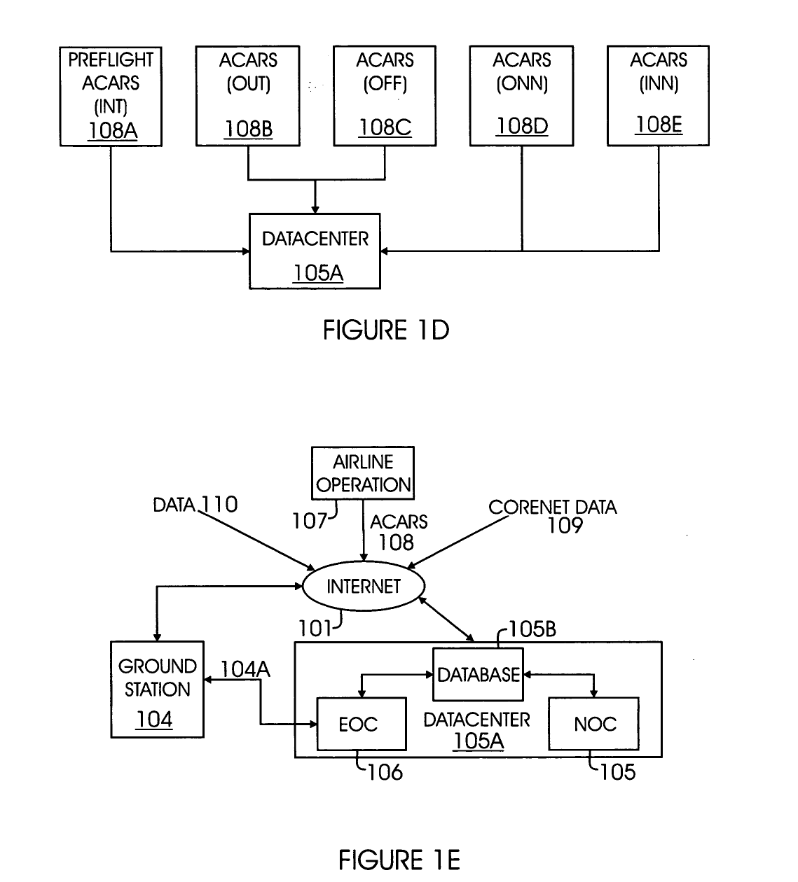

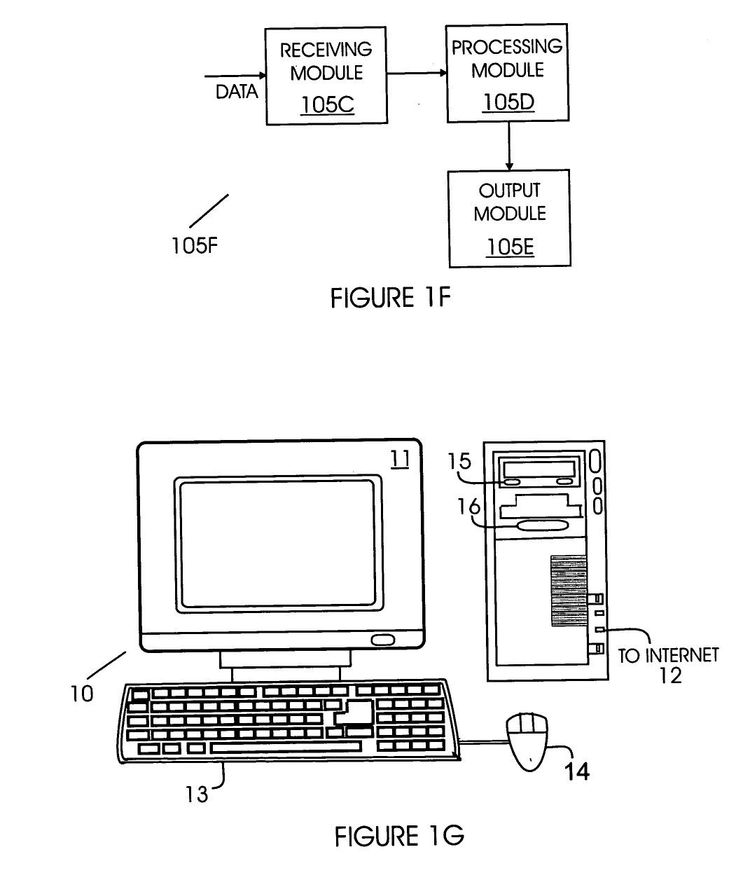

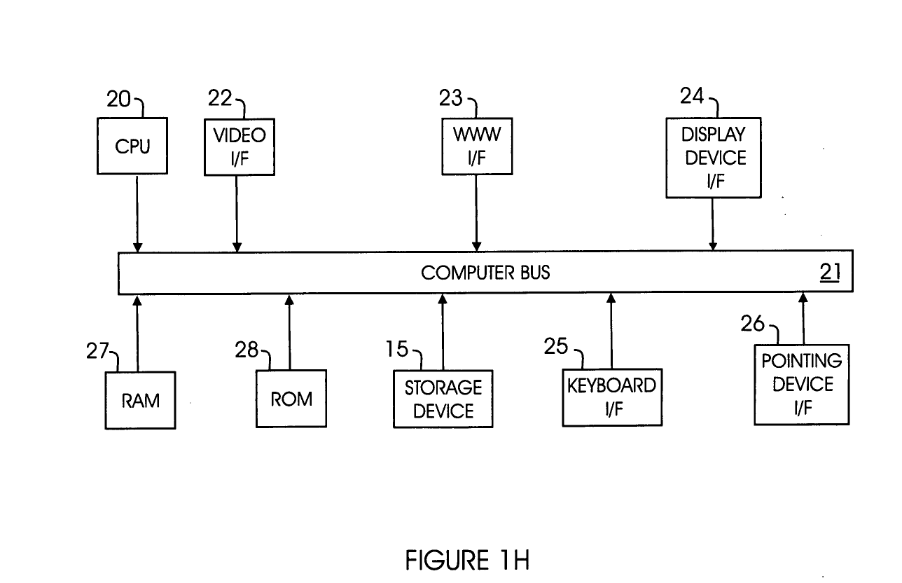

FIG. 1A1 shows a top-level block diagram for monitoring the status of an ad-hoc network node 102B. Ad-hoc network node 102B can leave or join the network (e.g. the Internet) at any time. Node 102B is operationally coupled to a data collection center 103A that transmits node 102B data to a data center 105A. As discussed above, node 102B may be an aircraft, boat, train and/or automobile. Data center 105A includes an enterprise class operation center (“EOC”) 106 and network operation center (“NOC”) 105 that receive node 102B data via Internet 101 and/or data collection center 103A. Data center 105A monitors node 102B status and customers are billed based on overall status monitoring, as described below.

A block diagram for monitoring an aircraft (i.e. node 102B) will now be described with respect to FIGS. 1A-1E. Currently, ACARS (Aircraft Communications Addressing and Reporting System) a standard message format incorporated herein by reference in its entirety, SITA Flight Briefing Service and other similar systems report data on aircraft flight operations by sending and receiving radio frequency or facsimile messages from a ground station. ACARS and SITA collect information on an aircraft and send messages from the aircraft to a ground station where the messages are sent to a computer.

Real-time aircraft location/position data (may also be referred to as navigation data), for example, longitude and latitude of an airborne aircraft may be collected via satellites. An airplane communicates with one or more satellite and data is sent to a satellite gateway. The gateway in turn provides navigation data to one or more ground stations.

FIG. 1A shows a top-level block diagram for collecting real-time navigation data from an aircraft. An aircraft data center 102 located on aircraft 102A communicates with a satellite 103. As shown in FIG. 1A, plural aircrafts operate as ad-hoc network nodes. Data center 102 has the capability to connect to the Internet 101 via an Internet provider. Access to Internet 101 is provided for passengers and the aircraft 102A itself.

Satellite 103 collects aircraft 102A flight data and navigation data, which is then passed to satellite gateway 104, that is functionally, coupled to Internet 101 (described below) and/or to data center 105A.

Both NOC 105 and EOC 106 include at least a computing system for executing the computer-executable code, according to one aspect of the present invention. A description of a computing system used by NOC 105 and/or EOC 106 is provided below.

NOC 105 monitors a computing network by receiving input from plural sources, for example, ACARS messages, and real-time aircraft status information. NOC 105 processes the various inputs, according to the adaptive aspects of the present invention.

It is noteworthy that the invention is not limited to data center 105A architecture. NOC 105 and EOC 106 may be an integral part of data center 105A to execute the process steps of the present invention. The modular components shown in various figures and described herein are intended to illustrate the adaptive aspects of the present invention and not to limit the present invention to any particular configuration.

FIG. 1B shows another block diagram of the data collection system described above with respect to FIG. 1A. FIG. 1B shows plural ground stations 104A-104D that collect data from an aircraft while it is in transit. Ground stations 104A-104D are similar to satellite gateway 104. Ground station position data 107 includes the locations of plural ground stations 104A-104D and sends data to data center 105A. Data collected from the ground stations is processed by data center 105A, according to the adaptive aspects of the present invention.

FIG. 1C shows a block diagram for collecting ACARS messages that are used by data center 105A. Aircraft 102A via data center 102 provides status information to an airline operations center 107. ACARS message 108 is then sent to data center 105A via Internet 101 through airline operation center 107.

In one aspect, ACARS message 108 may be sent using electronic mail or file transfer protocol (“FTP”). It is noteworthy that the adaptive aspects of the present invention are not limited to any particular protocol or system for transferring ACARS messages. ACARS messages 108 may be stored in database 105B and is accessible to both NOC 105 and EOC 106 for processing, as described below.

FIG. 1D shows a block diagram with various stages for ACARS messages 108. In general, an ACARS message may include, the flight status (i.e., Pre-flight, Flight Out, Flight Off, Flight On and Flight In), pre-flight time, an Airline unique identifier, flight number, aircraft registration number, scheduled departure airport, scheduled time of departure, actual departure time from the gate, time the aircraft takes off, scheduled arrival airport, passenger count, actual arrival airport, actual landing time and arrival time at the gate.

ACARS pre-flight message (INT) 108A includes basic flight information, for example, departure city, scheduled departure time, scheduled arrival time, and scheduled arrival city.

Message ACARS (OUT) 108B includes, actual departure time and passenger loading. Message ACARS(OFF) 108C provides the time when the aircraft takes off and the time it is in the air.

Message ACARS (ONN) 108D provides the time when the aircraft lands and message 108E (ACARS (INN) provides the actual arrival time at the gate, actual arrival airport and arrival city.

FIG. 1E shows yet another block diagram of a data collection system that receives data 108, 109 and 110 from plural sources and are processed according to one aspect of the present invention, as described below. As discussed above with respect to FIG. 1C, ACARS messages 108 are received by data center 105A via Internet 101.

Ground station 104 provides real-time data, described above with respect to FIG. 1A. This data is collected by using Aircraft Inertial Reference Unit (“IRU”) standard interface, incorporated herein by reference in its entirety. Data 104A may be received by EOC 106 and includes, real-time latitude and longitude positions of the aircraft, IP address for data center 102; aircraft tail number; ground speed, tack angle, true heading, pitch angle, roll angle, body pitch angle, body role rate, body yaw rate, inertial altitude and inertial vertical speed.

Data 109 is received from aircraft data center 102 and includes an IATA airline identifier, flight number, aircraft's unique tail number, the actual departure airport, arrival airport, distance to destination, estimated time of arrival at destination and the time to destination.

Data 110 may be from any other source, for example, data from a government entity during an emergency and is received by data center 105A via the Internet 101. Data 110 may be delayed or real-time.

FIG. 1F shows a top-level block diagram of a system that executes the adaptive process steps, according to one aspect of the present invention. System 105F includes a receiving module 105C that receives data (104A, 108, 109, and/or 110) and forwards the data to processing module 105D for processing the data, according to the various adaptive aspects of the present invention. Output module 105E outputs the processed information to a designated source in one or more formats. It is noteworthy that system 105F may be located in NOC 105 and/or EOC 106.

Computing System:

FIG. 1G is a block diagram of a computing system for executing computer executable process steps according to one aspect of the present invention. FIG. 1G includes a host computer 10 and a monitor 11. Monitor 11 may be a CRT type, a LCD type, or any other type of color or monochrome display (or any other display device including a high definition television station).

Also provided with computer 10 are a keyboard 13 for entering data and user commands, and a pointing device 14 for processing objects displayed on monitor 11.

Computer 10 includes a computer-readable memory storage device 15 for storing readable data. Besides other programs, storage device 15 can store application programs including web browsers by which computer 10 connect to the Internet 101, and the computer-executable code according to the present invention.

According to one aspect of the present invention, computer 10 can also access computer-readable floppy disks storing data files, application program files, and computer executable process steps embodying the present invention or the like via a floppy disk drive 16. A CD-ROM, or CD R/W (read/write) interface (not shown) may also be provided with computer 10 to access application program files, and data files stored on a CD-ROM.

A modem, an integrated services digital network (ISDN) connection, or the like also provide computer 10 with an Internet connection 12 to the World Wide Web (WWW). The Internet connection 12 allows computer 10 to download data files, application program files and computer-executable process steps embodying the present invention from Internet 101.

It is noteworthy that the present invention is not limited to the FIG. 1G architecture. For example, notebook or laptop computers, handheld devices, set-top boxes or any other system capable of running computer-executable process steps, as described below, may be used to implement the various aspects of the present invention.

FIG. 1H is a block diagram showing the internal functional architecture of computer 10. As shown in FIG. 1H, computer 10 includes a central processing unit (“CPU”) 20 for executing computer-executable process steps and interfaces with a computer bus 21. Also shown in FIG. 1H are a video interface 22, a WWW interface 23, a display device interface 24, a keyboard interface 25, a pointing device interface 26, and storage device 15.

As described above, storage device 15 stores operating system program files, application program files, web browsers, and other files. Some of these files are stored using an installation program. For example, CPU 20 executes computer-executable process steps of an installation program so that CPU 20 can properly execute the application program.

Random access memory (“RAM”) 27 also interfaces to computer bus 21 to provide CPU 20 with access to memory storage. When executing stored computer-executable process steps from storage device 15 (or other storage media such as floppy disk 16 or WWW connection 12), CPU 20 stores and executes the process steps out of RAM 27.

Read only memory (“ROM”) 28 is provided to store invariant instruction sequences such as start-up instruction sequences or basic input/output operating system (BIOS) sequences for operation of keyboard 13.

Computer-executable process steps, according to one aspect of the present invention may be performed using the Internet 101. The following provides a brief description of the Internet. Internet 101:

The Internet connects plural computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (XML) as published by W3C Consortium, Version 1, Second Edition, October 2000, ©W3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online or CompuServe, or via an Internet Service Provider, e.g., Earthlink. The web browser may run on any computer connected to the Internet. Currently, various browsers are available of which two prominent browsers are Netscape Navigator and Microsoft Internet Explorer.

The Web Browser receives and sends requests to a web server and acquires information from the WWW. A web server is a program that, upon receipt of a request, sends the requested data to the requesting user.

A standard naming convention known as Uniform Resource Locator (“URL”) has been adopted to represent hypermedia links and links to network services. Most files or services can be represented with a URL. URLs also enable two programs on two separate computers to communicate with each other through simple object access protocol (“SOAP”), extensible markup language (“XML”), and other protocols published by the W3C consortium, incorporated herein by reference in its entirety.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP). It is noteworthy that the invention is not limited to standard WWW or W3C protocols for server access and information exchange.

Process Flow:

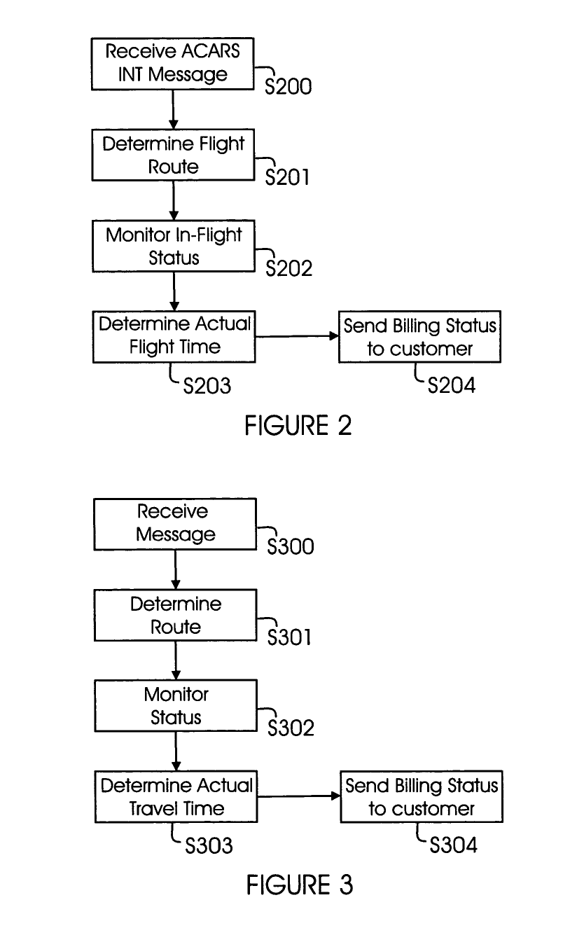

FIG. 2 shows a process flow diagram for billing customers for Internet access on an aircraft. In step S200, data center 105A receives ACARS (INT) message 108A. ACARS pre-flight message (INT) 108A includes basic flight information, for example, departure city, scheduled departure time, scheduled arrival time, and scheduled arrival city. NOC 105 also acquires the aircraft tail number. In step S201, based on message 108A, NOC 105 determines the potential route for aircraft 102A.

In step S202, data center 105A monitors the flight for aircraft 102A. This is performed, as described above by using data sources 108, 104A, 109 and 110. Based on the monitoring by data center 105A, NOC 105 at any given time is aware of where aircraft 102A is flying.

In step S203, NOC 105 determines the actual flight time. This is based on messages 108A and 108E. Data center 105A also knows the geographical area where the aircraft traveled.

In step S204, NOC 105 or EOC 106 provides a billing output. The billing output can be send to a customer via email. The billing output includes a summary of the total flight time and also highlights the areas where Internet access was available or not available for aircraft 102A. Billing output adjusts the flight time when Internet access was not provided. For example, if the flight was from London to Los Angeles, and while aircraft 102A was flying over certain part of the Atlantic ocean where Internet access was not available, then that duration is deducted from the total actual flight time. The adjusted time is used to bill the customer for Internet access. Therefore, in one aspect of the present invention, an accurate billing option is provided so that a customer can be accurately billed based on actual service. It is noteworthy that an authorized customer may access the flight status data to confirm the flight duration for billing purposes.

It is noteworthy that the present inventive billing process is not limited to any particular customer, for example, an airline; or any other entity can be billed by using the adaptive aspects of the present invention.

FIG. 3 shows a process flow diagram for billing customers for Internet access on a generic ad-hoc network node for example, ship, train, boat, aircraft and/or automobile). In step S300, data center 105A receives an initial message which may include basic information, for example, departure city, scheduled departure time, scheduled arrival time, and scheduled arrival city. The initial message notifies data center 105A that ad-hoc node 102B has started its operation.

In step S301, based on the initial message, NOC 105 determines the potential route for the ad-hoc network node.

In step S302, data center 105A monitors the ad-hoc network node. This is performed, as described above for an aircraft by using data sources 108, 104A, 109 and 110. A similar system may be used for other ad-hoc network nodes. Based on the monitoring by data center 105A, NOC 105 at any given time is aware of the ad-hoc network geographical location.

In step S303, NOC 105 determines the actual travel/operation time. Data center 105A also knows the geographical area where the ad-hoc node may have traveled.

In step S304, NOC 105 or EOC 106 provides a billing output. The billing output can be send to a customer via email. The billing output includes a summary of the total travel time and also highlights the areas where Internet access was available or not available. Billing output adjusts the travel time when Internet access was not provided. The adjusted time is used to bill the customer for Internet access. Therefore, in one aspect of the present invention, an accurate billing option is provided so that a customer can be accurately billed based on actual service.

Those skilled in the art will appreciate that there are adaptations and modifications of the just-described preferred embodiments that can be configured without departing from the scope and spirit of the invention. Therefore, it is to be understood, that within the scope of the intended claims, the invention may be practiced other than is specifically described herein.

1. A method for billing for Internet access for an ad-hoc network node, comprising:
receiving a message notifying when the ad-hoc network node starts operating;
determining a route for the ad-hoc network node; and
determining duration of Internet access to the ad-hoc network node during ad-hoc network node travel.

2. The method of claim 1, wherein the message is received by a monitoring system via the Internet.

3. The method of claim 1, further comprising:
generating a billing statement based on duration of travel and geographical area where Internet access is provided.

4. A computer-readable medium storing computer-executable process steps of a process for use in a computer system for billing for Internet access on an ad-hoc network node, comprising:
code for receiving a message notifying when the ad-hoc network node starts operating;
code for determining a route for the ad-hoc network; and
code for determining duration of Internet access to the ad-hoc network node during ad-hoc network node travel.

5. The computer readable medium of claim 4, wherein the message is received by a monitoring system via the Internet.

6. The computer readable medium of claim 4, further comprising:
code for generating a billing statement based on duration of travel and geographical area where Internet access is provided.

7. An apparatus for billing for Internet access for an ad-hoc network node, comprising:
a storage device for storing computer executable process steps; and
a processor for executing computer executable process steps for receiving a message notifying when the ad-hoc network node starts operating; determining a route for the ad-hoc network node; and determining the duration of Internet access to the ad-hoc network node during ad-hoc network node travel.

8. The apparatus of claim 7, wherein the message is received by a monitoring system via the Internet.

9. The apparatus of claim 7, the processor generates a billing statement based on duration of travel and geographical area where Internet access is provided.

10. A system for billing for Internet access for an ad-hoc network node, comprising:
a data center that receives a message notifying when the ad-hoc network node starts operating; determines a route for the ad-hoc network node and duration of Internet access to the ad-hoc network node during ad-hoc network node travel.

11. The system of claim 10, wherein the message is received via the Internet.

12. The method of claim 1, wherein the ad-hoc network node may be an aircraft, train, boat, ship and/or automobile.

13. The computer readable medium of claim 4 wherein the ad-hoc network node may be an aircraft, train, boat, ship and/or automobile.

14. The apparatus of claim 7, wherein the ad-hoc network node may be an aircraft, train, boat, ship and/or automobile.

15. The system of claim 10, wherein the ad-hoc network node may be an aircraft, train, boat, ship and/or automobile.
